(19) United States
(12) Patent Application Publication
(10) Pub. No.: US 2006/0287980 A1
(43) Pub. Date: Dec. 21, 2006

(54) Intelligent search results blending

(75) Inventors: Jun Liu, Bellevue, WA (US); Adwait Ratnaparkhi, Redmond, WA (US); Qi Yao, Sammamish, WA (US); Sanjeev Katariya, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/157,599

(22) Filed: Jun. 21, 2005

(51) Int. Cl. G06F 17/30

(52) U.S. Cl. 707/2

(57) ABSTRACT

The subject invention relates to systems and methods that automatically combine or interleave received search results from across knowledge databases in a uniform and consistent manner. In one aspect, an automated search results blending system is provided. The system includes a search component that directs a query to at least two databases. A learning component is employed to rank or score search results that are received from the databases in response to the query. A blending component automatically interleaves or combines the results according to the rank in order to provide a consistent ranking system across differing knowledge sources and search tools.

### TECHNICAL FIELD

The subject invention relates generally to computer systems, and more particularly, relates to systems and methods that employ machine learning techniques to rank and order search results from multiple search sources in order to provide a blended return of the results in terms of relevance to a search query.

### BACKGROUND OF THE INVENTION

Given the popularity of the World Wide Web and the Internet, users can acquire information relating to almost any topic from a large quantity of information sources. In order to find information, users generally apply various search engines to the task of information retrieval. Search engines allow users to find Web pages containing information or other material on the Internet or internal databases that contain specific words or phrases. For instance, if they want to find information about a breed of horses known as Mustangs, they can type in “Mustang horses”, click on a search button, and the search engine will return a list of Web pages that include information about this breed. If a more generalized search were conducted however, such as merely typing in the term “Mustang,” many more results would be returned such as relating to horses or automobiles associated with the same name, for example.

There are many search engines on the Web along with a plurality of local databases where a user can search for relevant information via a query. For instance, AllTheWeb, AskJeeves, Google, HotBot, Lycos, MSN Search, Teoma, and Yahoo are just a few of many examples. Most of these engines provide at least two modes of searching for information such as via their own catalog of sites that are organized by topic for users to browse through, or by performing a keyword search that is entered via a user interface portal at the browser. In general, a keyword search will find, to the best of a computer's ability, all the Web sites that have any information in them related to any key words or phrases that are specified in the respective query. A search engine site will provide an input box for users to enter keywords into and a button to press to start the search. Many search engines have tips about how to use keywords to search effectively. The tips are usually provided to help users more narrowly define search terms in order that extraneous or unrelated information is not returned to clutter the information retrieval process. Thus, manual narrowing of terms saves users a lot of time by helping to mitigate receiving several thousand sites to sort through when looking for specific information.

In addition to the type of query terms employed in a search, returned results from the search are often ranked according to a determined relevance by the search engine. Sometimes, non-relevant pages make it through in the returned results, which may take a little more analysis in the results to find what users are looking for. Generally, search engines follow a set of rules or an algorithm to order search results in terms of relevance. One of the main rules in a ranking algorithm involves the location and frequency of keywords on a web page. For instance, pages with the search terms appearing in the HTML title tag are often assumed to be more relevant than others to the topic. Search engines will also check to see if the search keywords appear near the top of a web page, such as in the headline or in the first few paragraphs of text. One assumption is that any page relevant to the topic will mention those words from the beginning. Frequency is the other major factor in how search engines determine relevancy. A search engine will analyze how often keywords appear in relation to other words in a web page. Those with a higher frequency are often deemed more relevant than other web pages. Unfortunately, there is no standard for ranking documents from different search engines, whereby different search engine algorithms rank results inconsistently from one another.

One problem with current searching techniques relates to how to compare, rank, and/or display information that may have been retrieved from multiple database sources. For instance, some users may desire to query two or more internet search engines with the same query and then analyze the returned results from the respective queries. At the same time, the users may query a local or community database to determine what new information may have been generated on those sites. As can be appreciated, each site may return a plurality of results, wherein the results are ranked according to different standards per the respective sites. Consequently, it is difficult for users to determine the importance or relevance of returned information given the somewhat incompatible ranking standards that are employed by different search tools. Also, this type of searching and analysis can take particularly large amounts of time to sift through results from each site and also to manually prioritize the information received given that some sites or engines likely may rank returned documents or information sources differently. Thus, in one case, one search engine may return a more important result—given the nature of the query, farther down the list of returned results than a second search engine.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention relates to systems and methods that utilize machine learning techniques to analyze query results from multiple search sources in order to blend results across the sources in terms of relevance. In one aspect, one or more learning components (e.g., classifiers) are adapted to search engine databases to determine relevance of information residing on a respective database. The learning components can be trained from a plurality of factors such as query term frequency appearing in a database, how recent a term has been used, time considerations, the number of times a given term has been searched for on a given database, the number of document examinations requested from the database, other metadata considerations and so forth. After training, the learning components can be employed as an overall scoring system that can be applied to multiple databases in view of a given query. For instance, a scoring or blending ratio can be determined and assigned to results from different databases or regions of a database indicating the relevance of information found therein. Upon determining the ratio, results returned from different sources can be automatically blended or mixed in display format according to the determined ratio or score. For instance, in a first database, it may be determined that the results are 2 to 1 more likely than another database that is scored as 1 to 1 given a respective query. Thus, results can be automatically blended as output to the user, in this case, the first two search results would be shown from database 1 followed by one result from database 2, followed by two results from database 1 and so forth. In this manner, results can be ranked consistently across search tools in order to mitigate the amount of time to find desired information and uncertainty in determining relevance of information from a given source. As can be appreciated, a plurality of blending ratios or scores can be determined.

To the accomplishment of the foregoing and related ends, certain illustrative aspects of the invention are described herein in connection with the following description and the annexed drawings. These aspects are indicative of various ways in which the invention may be practiced, all of which are intended to be covered by the subject invention. Other advantages and novel features of the invention may become apparent from the following detailed description of the invention when considered in conjunction with the drawings.

### BRIEF DESCRIPTION OF THE DRAWINGS

FIG. 1 is a schematic block diagram illustrating an automated ranking system in accordance with an aspect of the subject invention.

FIG. 2 is a diagram illustrating example ranking criteria in accordance with an aspect of the subject invention.

FIG. 3 illustrates an example user interface in accordance with an aspect of the subject invention.

FIG. 4 is a flow diagram illustrating an automated results blending process accordance with an aspect of the subject invention.

FIG. 5 illustrates example model training and testing system in accordance with an aspect of the subject invention.

FIG. 6 illustrates example query logs in accordance with an aspect of the subject invention.

FIG. 7 illustrates example model determination in accordance with an aspect of the subject invention.

FIG. 8 illustrates an example model test data in accordance with an aspect of the subject invention.

FIG. 9 is a schematic block diagram illustrating a suitable operating environment in accordance with an aspect of the subject invention.

FIG. 10 is a schematic block diagram of a sample-computing environment with which the subject invention can interact.

### DETAILED DESCRIPTION OF THE INVENTION

The subject invention relates to systems and methods that automatically combine or interleave received search results from across knowledge databases in a uniform and consistent manner. In one aspect, an automated search results blending system is provided. The system includes a search component that directs a query to at least two databases. A learning component is employed to rank or score search results that are received from the databases in response to the query. A blending component automatically interleaves or combines the results according to the rank in order to provide a consistent ranking system across differing knowledge sources and search tools. This enables searches over a variety of information types and providers—some coming from within and some from the outside a given search domain. Internally, for those searches that come from within, the search system utilizes multiple evidence factors to produce ranked retrieval. Automated combination of these multiple evidence factors results in what is referred to as “results blending” or blending results that are received from disparate ranking systems in an adaptive manner. Thus, an adaptive interleaving approach is provided to blend search results that leads to more enhanced machine learning approaches which can also be guided by user interaction data.

As used in this application, the terms “component,” “system,” “engine,” “query,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

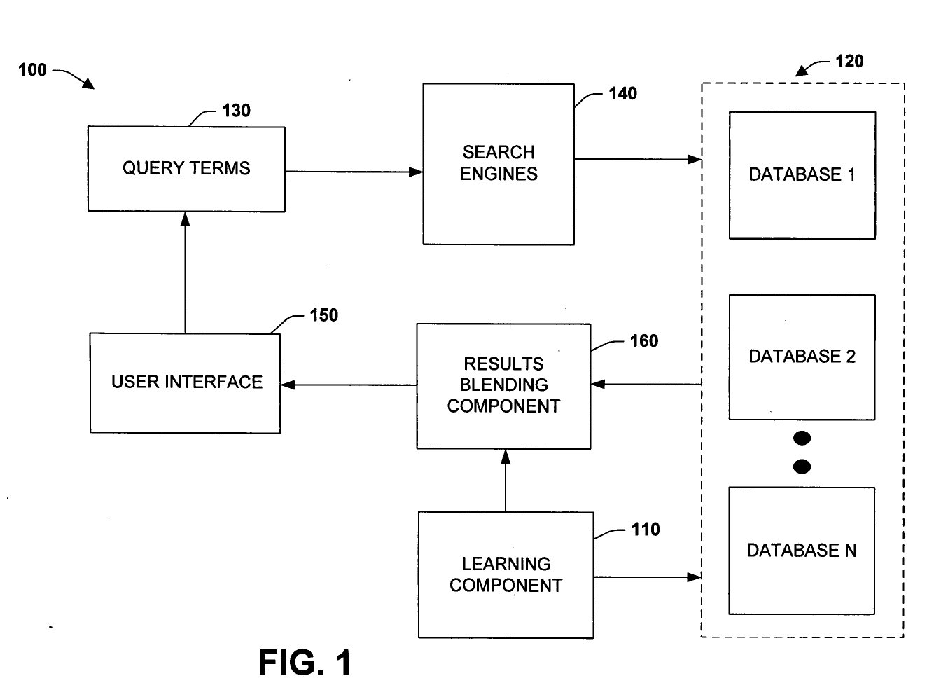

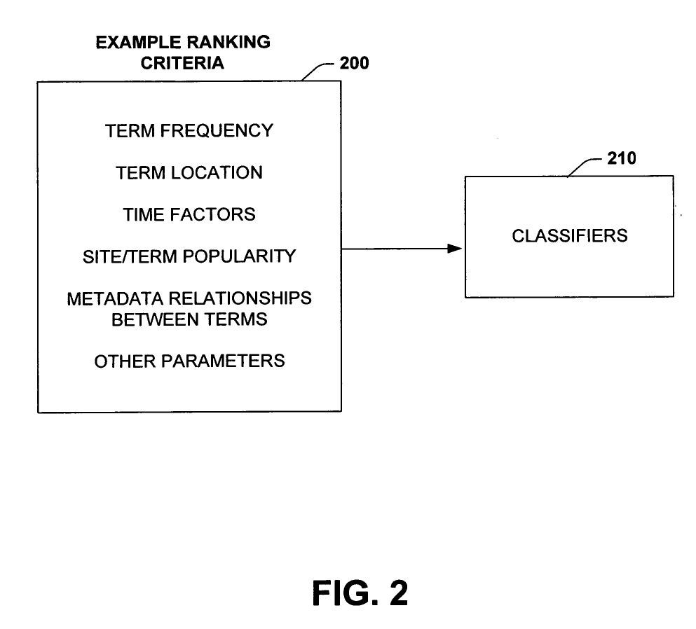

Referring initially to FIG. 1, an automated ranking system 100 is illustrated in accordance with an aspect of the subject invention. The system 100 includes one or more learning components 110 that are associated with a plurality of search engine databases 120 to determine relevance of information residing on a respective database and in general—across the spectrum of databases. Such databases 120 can be local in nature such as a local company data store, remote in nature such as across the Internet, and/or include combinations of local and remote databases. The learning components 110 can be trained from a plurality of factors that are described in more detail below with respect to FIG. 2. As illustrated, one or more query terms 130 are submitted to a plurality of search engines 140 (or tools) via a user interface 150 in order to retrieve search results from the respective databases 120. The results from the searches are combined by an automated results blending component 160, wherein the combined results are returned to the user interface 150 for display and further processing if desired.

After training, the learning components 110 can be employed as an overall scoring system that can be applied to multiple databases 120 based a given query 130. For instance, a scoring or blending ratio can be determined and assigned to results from different databases 120 or regions of a database indicating the relevance of information found therein. Upon determining the ratio or score, results returned from different sources can be automatically blended or mixed in display format according to the determined ratio or score at the user interface 150. For instance, in a first database 120, it may be determined that the results are 3 to 1 more likely than another database that is scored as 2 to 1 given a respective query. Thus, results can be automatically blended as output by the blending component 160 for the user. In this case, the first three search results would be shown from database 1 followed by two results from database 2, followed by three results from database 1 and so forth. In this manner, results can be ranked consistently across search engines 140 and databases 120 in order to mitigate the amount of time to find desired information and uncertainty in determining relevance of information from a given source.

To illustrate some of the blending concepts described above, the following specific examples are described. In one case, to search for an answer to a problem, a user has different choices that may include a vendor database, their own computer (Local content), a corporate website, a product website, an OEM website (e.g., Dell), newsgroups, and Internet Search sites to name but a few examples. Thus, the user would select a content provider to conduct a search for information and they also may need to search in multiple places. Currently, results from different search providers cannot be compared easily. One solution is to employ 1-1 interleaving of results that are received from the databases 120. This implies that each site is represented equally (e.g., top result from site 1 ranked with top result from site 2, second result from site 1 ranked and displayed with second result from site 2 and so forth).

In accordance with the subject invention, in addition to 1-1 ranking of results from disparate information sources, intelligent blending of results can be provided which are based on the learning components 110. As will be shown in tests results below, there is value provided to users by employing intelligent blending of results over a 1-1 blending strategy. Thus, search results can be automatically presented from different content providers in a “blended” or combined format at the user interface 150. In one example, this includes providing a unified and ordered list of results at the user interface 150, regardless of where the information comes from or from which database 120.

To illustrate the basic outlines for blending the following contrasts a 1-1 strategy to a blended results strategy. As will be shown below, search results using intelligent blending (with learning) provides a more relevant data presentation than search results using 1 to 1 interleaving. In a 1-1 Interleaving strategy, results are interleaved, one from each provider in order. For instance:

Given providers a, b, c with result sets:
{a1, a2, a3}
{b1, b2} and
{c1}
   yields a blended result set having a 1-1 interleave of: a1, b1, c1, a2, b2, a3. It is to be appreciated that many more databases and returned results can be processed in accordance with the subject invention.

Rather than a straight 1-1 interleave approach, each data provider can be considered an “expert” in its own domain of knowledge as supported by the databases 120. This expertise can be exploited to influence intelligent blending as described above.

With intelligent blending, a weighted Interleaving strategy is employed by the results blending component 160 and in accordance with the learning component 110. In this case, data providers are automatically given a ranking using the numbers from a model and classifier (or other learning component) described in more detail below. For this example, given providers a, b, and c with result sets as follows:
{a1, a2, a3}
{b1, b2}
{c1}
   and example weighting a=2, b=1, c=1 (given by a classifier). Then a blended result set in this example would appear as: a1, a1, c1, a3, b2. Thus, rather than merely interleaving results on a 1-1 basis, automated weighting allows results to be ranked and displayed according to a determined relevance for all sources across disparate databases 120.

Referring briefly to FIG. 2, example ranking criteria 200 that can be employed by one or more classifiers 210 are illustrated in accordance with an aspect of the subject invention. As noted above, classifiers 210 can be trained from various data sources and can assign weights to terms found in a respective source. In one example, as illustrated at 210, the weights can be assigned based upon the frequency or number of times a given term appears in a database. For instance, a community or support database may have a high frequency of terms relating to a recent computer virus over existing web sources and thus may possibly be scored with a higher weight for a query having terms relating to the particular virus. In another case, location of the term within the database or within files on the database can be employed as ranking criteria. Still yet other factors that can be analyzed by the classifiers 210 include time-based factors. For instance, the newness of a term or how recent it has been used on one type of database may provide a higher weighting given the nature of the query. Other ranking criteria 200 can include analyzing how often a particular data source is accessed or how popular the source is (e.g., the number of times a source has been clicked on). Various metadata associated with site data can also be analyzed and weighted. For instance, certain terms that appear in a given query may be given different rankings based upon learned relationships with other words, clusters, or phrases. As can be appreciated, a plurality of factors or other parameters can be employed for ranking results from databases in view of a given query.

It is noted that various machine learning techniques or models can be applied by the learning components described above. The learning models can include substantially any type of system such as statistical/mathematical models and processes for modeling data and determining results including the use of Bayesian learning, which can generate Bayesian dependency models, such as Bayesian networks, naïve Bayesian classifiers, and/or other statistical classification methodology, including Support Vector Machines (SVMs), for example. Other types of models or systems can include neural networks and Hidden Markov Models, for example. Although elaborate reasoning models can be employed in accordance with the present invention, it is to be appreciated that other approaches can also utilized. For example, rather than a more thorough probabilistic approach, deterministic assumptions can also be employed (e.g., terms falling below a certain threshold amount at a particular web site may imply by rule be given a score). Thus, in addition to reasoning under uncertainty, logical decisions can also be made regarding the term weighting and results ranking.

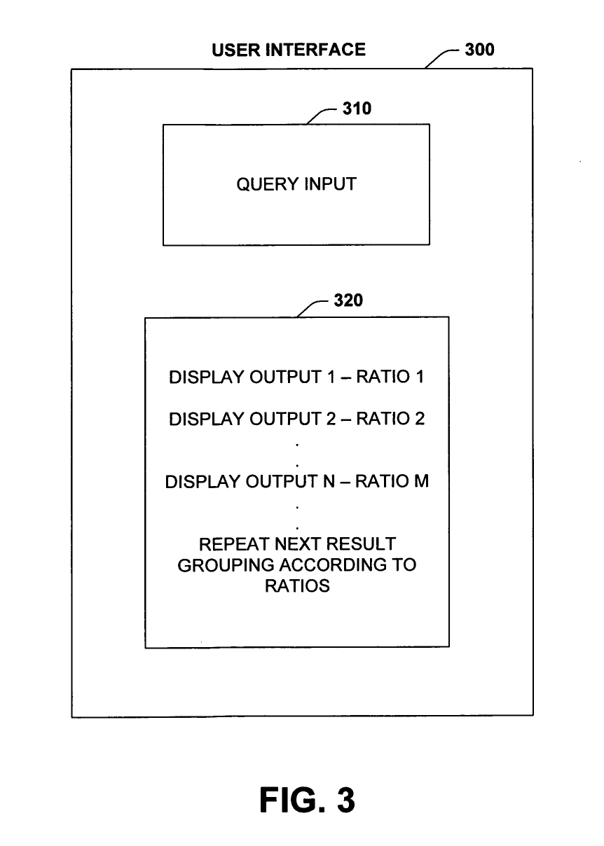

Turning now to FIG. 3, an example user interface 300 is illustrated in accordance with an aspect of the subject invention. The interface 300 includes a query input location 310 (or box) for entering a query that is submitted to a plurality of databases as described above. This can include capabilities for entering typed terms for search or more elaborate inputs such as a speech encoder for receiving the query terms. When the terms are submitted to the databases, results are ranked from each database independently via the learning components described above. A blending component (not shown) then interleaves the results according to weights that are assigned to the terms by the learning components.

A unified display of all returned results is illustrated at 320. This includes display output of N results which are interleaved or combined according to M blending ratios, wherein N and M are positive integers, respectively. For instance, the first four results at the display 320 may be provided from computations that indicate a ratio of 4-1 for results received from a first database, whereas the next two results may be from a different data base having a ratio determined at 2-1. Assuming two databases were employed in this example, the next four results would be listed from the first database proceeded by the next two results from the second database and so forth. In this manner, results can be blended across a plurality of sources and unified at the output display 320 to provide a consistent rank of relevance across the data sources. As noted above, a plurality of databases can be analyzed via learning components and as such, a plurality or results can be interleaved at the display 320 according to the weighted ranking described above.

Before proceeding, it is noted that the user interfaces described above can be provided as a Graphical User Interface (GUI) or other type (e.g., audio or video interface providing results). For example, the interfaces can include one or more display objects (e.g., icons, result lists) that can include such aspects as configurable icons, buttons, sliders, input boxes, selection options, menus, tabs and so forth having multiple configurable dimensions, shapes, colors, text, data and sounds to facilitate operations with the systems described herein. In addition, user inputs can be provided that include a plurality of other inputs or controls for adjusting and configuring one or more aspects of the subject invention. This can include receiving user commands from a mouse, keyboard, speech input, web site, browser, remote web service and/or other device such as a microphone, camera or video input to affect or modify operations of the various components described herein.

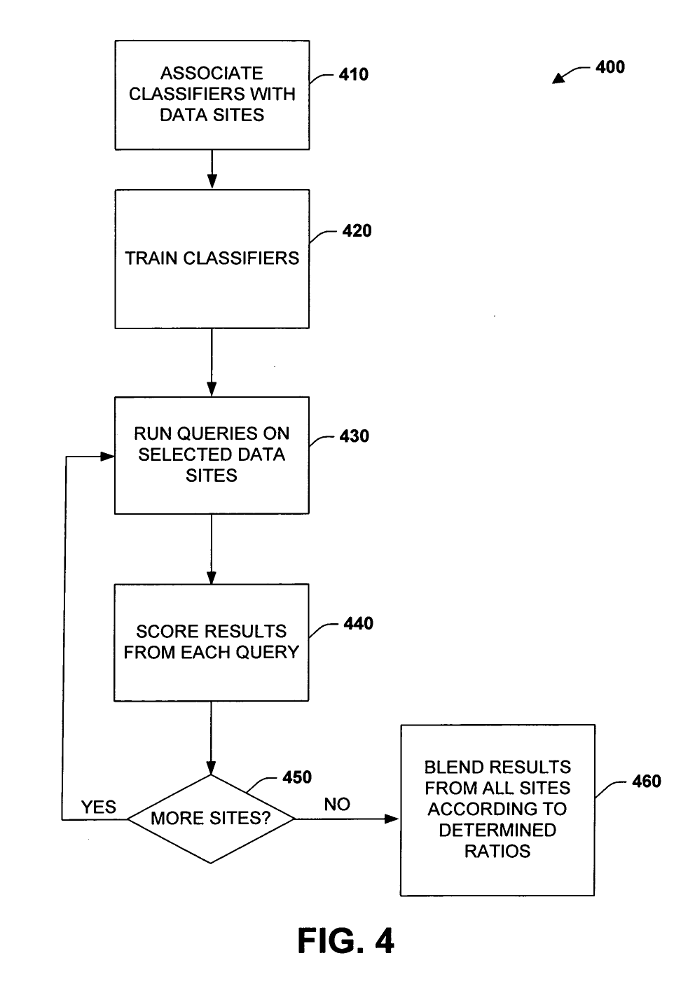

FIG. 4 illustrates an automated blending process 400 in accordance with an aspect of the subject invention. While, for purposes of simplicity of explanation, the methodology is shown and described as a series or number of acts, it is to be understood and appreciated that the subject invention is not limited by the order of acts, as some acts may, in accordance with the subject invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

Proceeding to 410, one or more classifiers are associated with various data sites to be searched. As noted above, other types of machine learning can be employed in addition to classifiers. At 420, the respective classifiers are trained according to the terms appearing at the data sites. This can include a plurality of factors such as term frequency, location, time factor, and/or other considerations such relationships to other terms or metadata appearing at the sites. At 430, queries having one or more terms are run at a given or selected data site. After submitting the query to the site, results from the query are scored via the classifier described at 410. This can include assigning a weight to each query term submitted to the site to determine data relevance or potential for knowledge at the selected site. Proceeding to 450, a determination is made as to whether or not to search a subsequent data site. If so, the process proceeds back to 430, runs the aforementioned query on the next data site and scores the terms for the next site at 440. If all searches have been conducted for the respective data sites at 450, the process proceeds to 460.

At 460, the returned search results which have been scored for all the sites are blended or interleaved according to the scores assigned at 440. As noted above, blending can occur according to determined ratios for each scored data site. For instance, the top K sites are first displayed in a blended results output, followed by the top L results from a second site, followed by the top M results from a third site and so forth. The second top K results from the first site are displayed, followed by the second top L results, followed by the third top M results, wherein this process continues until all results are displayed in a blended or interleaved manner. It is noted, that if results from a given site are exhausted, the blending continues from the remaining results left from the remaining sites in the proportioned ratios or ranking described above.

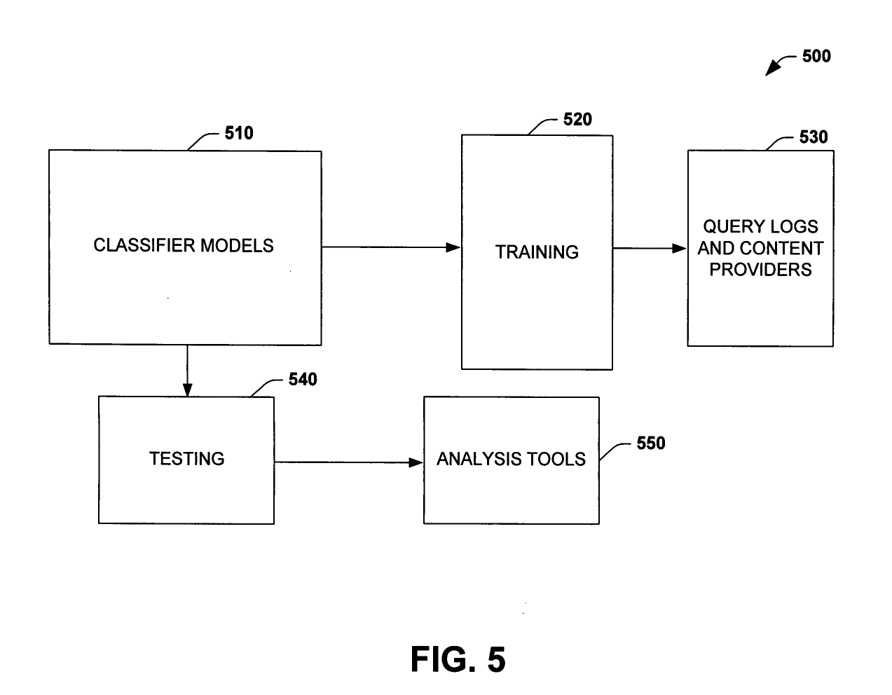

FIG. 5 illustrates a model training and testing system 500 in accordance with an aspect of the subject invention. In this aspect, one or more classifier models 510 go through various amounts of training overtime as illustrated at 520. For instance such training can occur at various query logs or data content providers at 530. After the classifiers 510 have been trained, various testing 540 can occur via software components or analysis tools for interpreting ranked and blended data.

In one specific example, training occurs at the query logs and content providers 530, wherein four different content providers include:

a) support.company.com

b) newsgroups.company.com

c) office.company.com (ISV content) and

d) support.company.com (OEM content)

The classifier 510 then determines the probability that a given query word (or phrase) originates from a particular provider. Testing 540 can include determining the efficacy of query/results blending which can include a graphical user interface (GUI) tool for producing queries and subsequently rating results received therefrom. Analysis tools 550 can include merging components, evaluation components, and measurement components that are employed to create a unified set of results or blended sets having measured results.

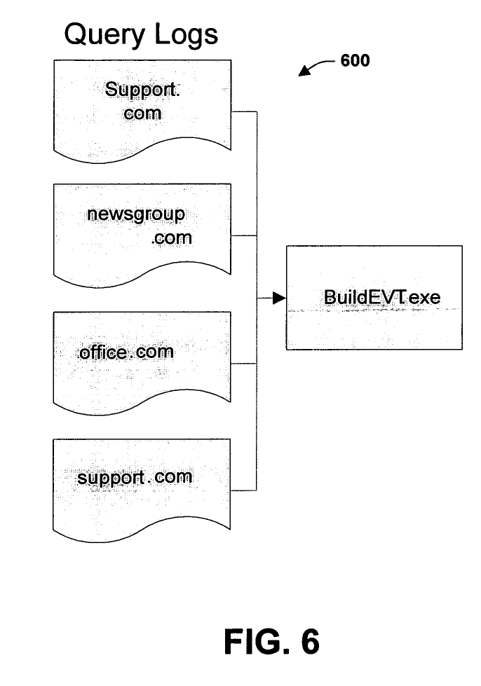

FIG. 6 illustrates example query logs 600 in accordance with an aspect of the subject invention. In this example, actual queries are received from each of the illustrated content providers. The queries were run in this example on each provider and collected the first page of results (typically 15-25). They were stored as flat files having a Title, Description, and a universal resource locator (URL) in order to maintain search data in a constant manner. However, it is to be appreciated that other types of data can be maintained and in a differing manner than constant as described herein. In general, breakdown of the example content illustrated at 600 was about: 65% from support.com, 15% from newsgroup.com, 10% office.com, and 10% support.com. As can be appreciated, a plurality of other type sites can be analyzed having differing amounts of data analyzed from each respective site.

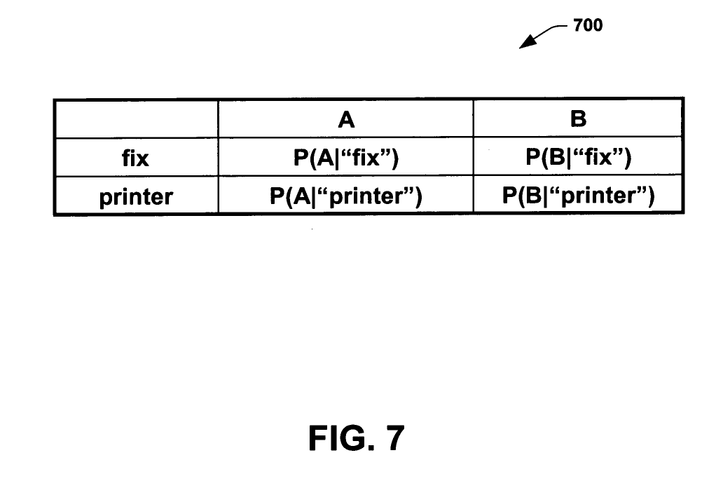

FIG. 7 illustrates an example model determination 700 in accordance with an aspect of the subject invention. In this example, which relates to the data providers described in FIGS. 5 and 6, a example search term “fix printer” is illustrated, whereby each term is assigned a probability in the model 700 displayed in separate rows and two data sources A and B are shown in separate columns that probability determinations will be made for each term in the given database. Thus, the model creates a matrix of probabilities at 700 which the classifier uses. For instance, given the query Q=“fix printer”, and providers A and B, the model calculates the chart depicted at 700. Thus, given the query Q=“fix printer” and providers A and B, the classifier determines:
P(A|Q)
P(B|Q)
   where P is a probability of a database A or B given|evidence found in the database from the query Q. In this example, to train the classifier, test queries were split into 80% for training (i.e., input to model) and 20% for testing.

Using a Blending Query component, queries were run using content from support.com mentioned above, wherein queries were are also arranged in a similar breakdown as described above. Then, each result was ranked at a given content provider described above. This process of running queries and ranking according to the probabilities shown at 700 is then repeated for each respective data site described above. After all sites have been ranked, in this example according to the term query terms “fix printer” all the rankings can be automatically merged into a blended set for results analysis.

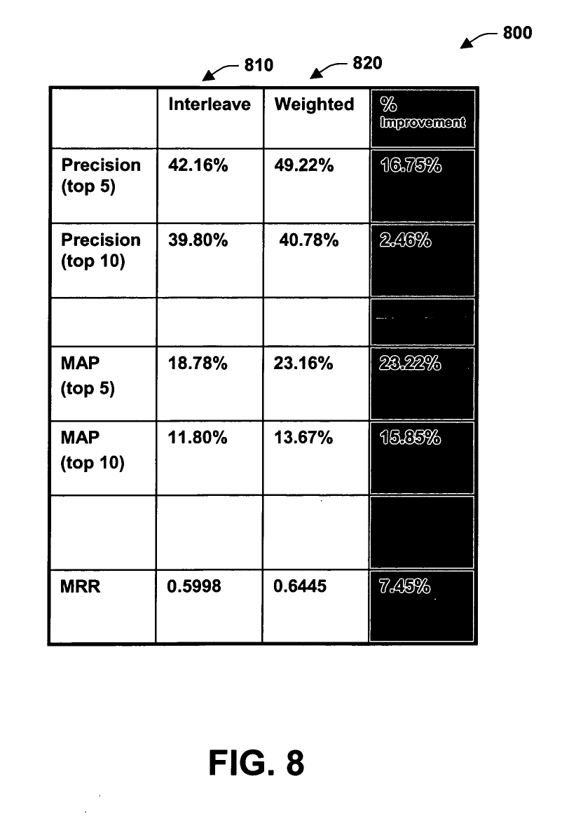

FIG. 8 illustrates an example test data 800 in accordance with an aspect of the subject invention. The test data 800 shows results from 100 different queries whereby results ranked in a 1-1 interleave manner are depicted in a column at 810, and results from weighted rankings are depicted in a column at 820. As illustrated, blended or weighted rankings provide improved results over straight-line interleaving as judged by a plurality of users that utilized such results. It is believed that better performance can be attained than illustrated at 700. Some factors for improvement in results include: allowing click-through data instead of query logs to train classifiers; employing larger data sets to yield better trained classifiers and also providing more query samples for training; rating a larger subset of logs; and allowing more users to provide rating data to mitigate potential bias.

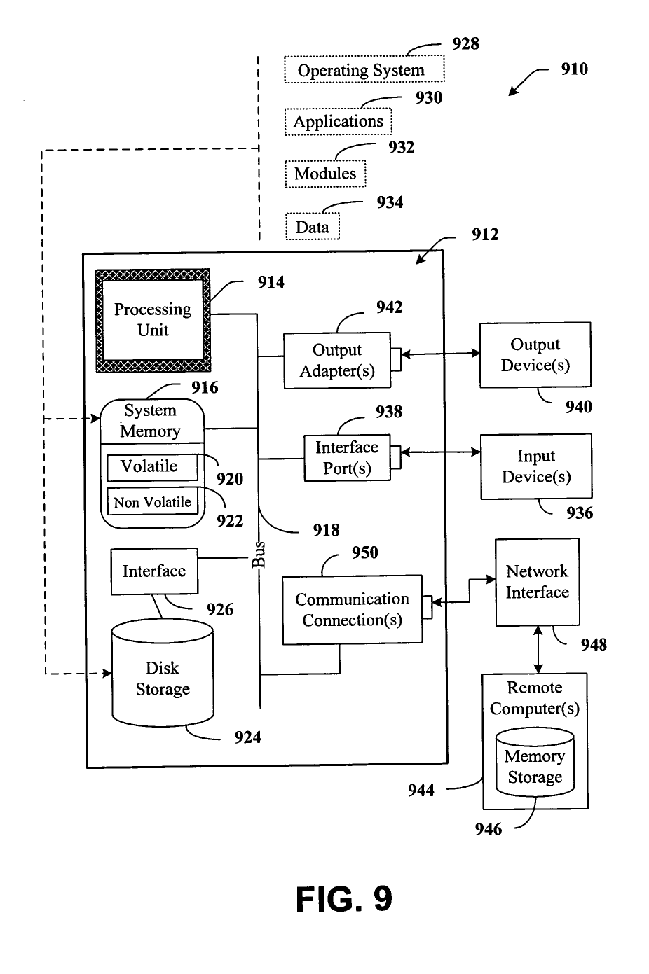

With reference to FIG. 9, an exemplary environment 910 for implementing various aspects of the invention includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates, for example a disk storage 924. Disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that the subject invention can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940, that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

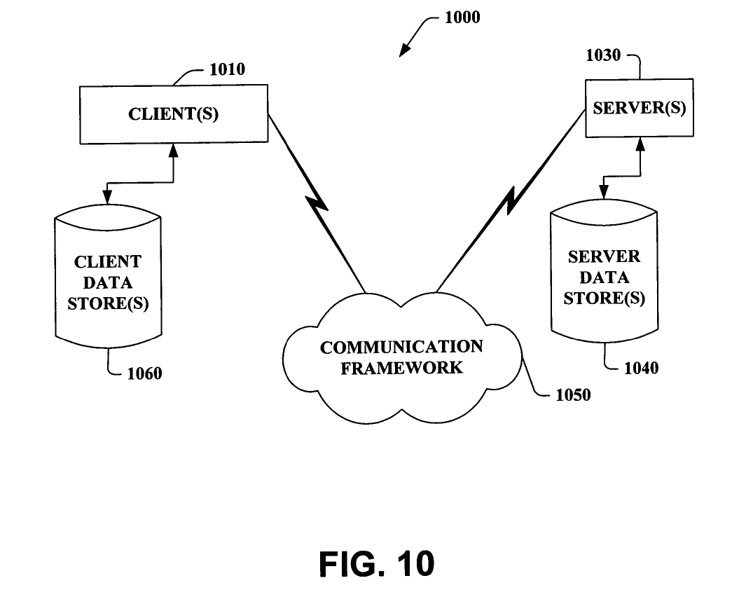

FIG. 10 is a schematic block diagram of a sample-computing environment 1000 with which the subject invention can interact. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the subject invention, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operably connected to one or more client data store(s) 1060 that can be employed to store information local to the client(s) 1010. Similarly, the server(s) 1030 are operably connected to one or more server data store(s) 1040 that can be employed to store information local to the servers 1030.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An automated search results blending system, comprising:
a search component that directs a query to at least two databases;
a learning component that is employed to rank search results received from the databases; and
a blending component that interleaves the results according to the rank.

2. The system of claim 1, the learning component employs at least one Bayesian classifier.

3. The system of claim 2, the Bayesian classifier determines a probability of a search term given evidence of the search term in the databases.

4. The system of claim 1, the evidence relates to a term frequency, a term location, a time factor, or metadata describing relationships between terms.

5. The system of claim 1, further comprising a graphical user interface for submitting queries to the search component or to display the results.

6. The system of claim 5, the user interface displays the results according to a blending ratio determined from the results.

7. The system of claim 1, the databases are associated with a query log.

8. The system of claim 1, the search component is associated with a search engine or a search tool.

9. The system of claim 1, further comprising a merging tool and a measuring tool for analyzing the results.

10. The system of claim 1, further comprising a component to process at least one of a training data set and a test data set.

11. The system of claim 1, further comprising a component to at least one of train a runtime classifier, evaluate a runtime classifier, analyze a runtime classifier, and diagnose a runtime classifier.

12. The system of claim 1, further comprising a component to organize files from the databases.

13. The system of claim 12, the files include at least one of a title, a description, and a universal resource locator (URL).

14. A computer readable medium having computer readable instructions stored thereon for implementing the components of claim 1.

15. An automated query result ranking method, comprising:
submitting a query to at least two search engines;
automatically classifying a plurality of terms in databases associated with the search engines;
determining a blending ratio for search results associated with the terms in the databases; and
combining the search results in a output display according to the blending ratio.

16. The method of claim 15, further comprising determining a probability for the terms.

17. The method of claim 16, further comprising determining the probability for the terms based at least in part on a frequency of the terms appearing in the database.

18. The method of claim 15, further comprising providing a user interface to interact with the search engines.

19. The method of claim 15, the databases include local or remote networked databases.

20. A system to facilitate computer ranking operations, comprising:
means for querying a plurality of databases;
means for ranking data within the databases;
means for automatically blending search results from the databases in view of the ranking; and
means for automatically displaying the search results from the plurality of databases.
